(19) United States
(12) Patent Application Publication
(10) Pub. No.: US 2011/0247636 A1
(43) Pub. Date: Oct. 13, 2011

(54) Nipple/Areola Protective Cover

(76) Inventor: Larry H. Pollack, San Diego, CA (US)

(21) Appl. No.: 12/758,490

(22) Filed: Apr. 12, 2010

(51) Int. Cl. A61J 13/00

(52) U.S. Cl. 128/890

(57) ABSTRACT

A protective cover for nipples and areolas employable during nipple or breast reconstructive surgery. The device has an axial cavity in a central portion of a resilient body employable for placement about the nipple or reconstructed nipple therein. The device is infinitely customizable in axial cavity diameter and vertical height by means of one or a plurality of removably engaged central portions.

### BACKGROUND OF THE INVENTION

1. Field of the Invention

This invention relates to medical devices employed for patient bandaging. More particularly, the disclosed device and method relate to medical devices employed during nipple reconstructive surgery and related surgeries. The disclosed device and method herein, provide a particular improvement in the art of bandaging a surgical patient to provide a means to protect the nipple and areola of a breast subsequent to reconstructive surgery.

2. Prior Art

Breast reconstructive surgeries have become commonplace in today's medical world whether the surgery is employed for medical reasons or for cosmetic purposes. Conventionally, breast reconstructive surgery and nipple related surgeries done concurrently or as a separate procedure, will involve a partial to full removal of the nipple and areola from the patient's breast.

In some surgeries, a nipple must be constructed by the surgeon who, using surgical skill, employs tissue taken from the patient's body and reconstructs a nipple in a proper position. In such cases, it is particularly crucial to protect the tissue, which as been sutured to simulate, and nipple while it heals and concurrently adheres to underlying body tissue. In all such surgeries, whether the surgeon is relocating the original nipple and areola or using body tissue to construct a new nipple to the breast area, during the healing process, there is an ongoing need to protect the transplanted tissues, while concurrently, providing support to ensure it's blood supply and survival during the reattached of the patient's tissue to the underlying tissue of their body.

Conventionally, it has been seen in common practice for physicians to employ their skills and various tools, bandages and other devices already employed within the operating room, to construct a bandage which protects from infection and concurrently provides a means to support and protect the covered tissue. One popular surgeon-prepared configuration employs a sterile plastic cap from a syringe base as the means to rigidly protect and stabilize the nipple tissue. To implement this procedure the surgeon situates the cap to cover the nipple and then wraps gauze over and around the cap and sutures the gauze to the skin around the areola for stability. This procedure is at times lengthy and requires much practice and tends to make the cessation of a surgery unpredictable causing decreased use of valuable operating rooms for other surgeries.

Additionally, there are many problems with this method. Given the rigidity of the cap portion of the syringe employed, there is a potential for it to sever off or over compress the tissue forming the nipple it protects. Additionally, since the gauze material used for support and padding is sewn to the skin, the resulting bandage is not water proof and can wick moisture past the skin barrier and showering must be avoided or extra care must be taken when showering.

In another problem with such bandaging, should the surgical site subsequently bleed or become infected, because the gauze is thick and has a bottom layer that is absorbent of fluids, the infection will not be noticeable to the patient. This lack of patient viewing capability can cause a significant increase in the travel and severity of the infection until the fluids draining from it have soaked through the padding to alert the patient.

Prior art as means to protect a nipple and areola such as that taught by US Pat. No. 2008/0009226 by Mouton. This device of Mouton encapsulates the nipple within an area surrounded by a protective ring. This ring is secured by a suppression device as to relax the protrusion of the nipple. This device is clearly for aesthetic reasons as related to fashion and provides little or no means of medical use.

US Pat. Publication No. 2006/0106329, Hammer and Clark, teaches a nipple reconstruction and protection device comprised of multiple components. The core component of the device contains an opening for the insertion within of the reconstructed nipple. However, Hammer fails to take into account that patients have varying nipple sizes and lacks adjustment for such. Further, the material of the device in Hammer is taught to be of high durometer rendering the device very hard which, if compressed by bandaging or impact, can damage the operation site. The Hammer device also lacks any means to determine the force or amount of pressure which is being applied to the nipple and areola tissue by the bandaging. Since excess pressure can cut off blood flow or damage tissues, Hammer lacks any provision to protect this important aspect of the healing process.

As such, there is an unmet need for a bandaging device and method, for surgeries on the breast involving the nipple and areola. Such a device should provide a standardized and fast means for surgeons to surround the nipple with an air gap, yet prevent contact or impact with the nipple which might cause damage or failure of the transplant. Such a device should impart sufficient pressure to the areola, to maintain it in place and allow re adherence to the underlying tissue, but prevent excess pressure which can cut off blood flow to nourish the tissue while it heals. Such a device should also provide means to measure the pressure imparted by the bandaging upon the protective component if the surgeon wishes to see some scale for pressure. Still further, such a device should provide a means for the patient or medical staff, to visually detect bleeding and/or infection should it occur, and to do so without removal of the device or the overlying bandage material.

With respect to the above, before explaining at least one preferred embodiment of the nipple bandaging device and method in detail or in general, it is to be understood that the invention herein is not limited in its application to the details of construction and to the arrangement of the components or the steps set forth in the following description or illustrated in the drawings. The various components and methods of the invention are capable of other embodiments, and of being practiced and carried out in various ways, all of which will be obvious to those skilled in the art, once the information herein is reviewed. Also, it is to be understood that the phraseology and terminology employed herein are for the purpose of description and should not be regarded as limiting.

As such, those skilled in the art will appreciate that the conception upon which this disclosure is based, may readily be utilized as a basis for designing other nipple bandaging systems, and for carrying out the several purposes of the present disclosed device and method. It is important, therefore, that the embodiments, objects and claims herein, be regarded as including such equivalent construction and methodology insofar as they do not depart from the spirit and scope of the present invention.

### SUMMARY OF THE INVENTION

The device and method herein disclosed and described provides a novel solution to the above noted shortcomings in the prior art of bandaging delicate tissues transplanted and reformed during breast reconstruction surgery. In use, the device and method of employment provides an easily employed means to protect the nipple tissue and areola tissue as needed for post operation of breast and/or nipple reconstructive surgery.

Used in combination with substantially transparent tape or bandaging, the device consists of a body formed of a cylindrical resilient member with a top surface, bottom surface, side wall, and central aperture surrounded by the annular ring portion of the resilient member. The body of the device is formed of resilient or pliable material which compresses predictably when biased against the tissue of the patient by an adhesive bandage layer. The durometer of the body material is such that it will not cause abrasion to the skin or tissue if compressed or slid.

In a preferred embodiment the cylindrical member forming the body, is formed with a diameter larger than the length of its height. A central axial chamber communicates an axial length of the cylindrical member and with both the top and bottom surfaces. This chamber is best formed of a diameter to leave a slight gap between the projecting nipple tissue and the interior wall defining the axial chamber.

In use, upon the cessation of the surgery, the nipple will be positioned in the axial chamber in a manner to be surrounded by the protective interior wall of the cylindrical member and with a slight gap therebetween.

Thereafter, a clear or transparent tape or bandage material is positioned to cover the body and adhesively engage the patient's skin surrounding the areola which is covered by the bottom surface of the body. A slight but uniform pressure is exerted to slightly compress the material forming the body in the direction of its center axis. This compression and resulting outward biasing of the material forming the cylindrical body provide a means to exert a controlled bias of the underlying skin forming the areola, against underlying tissue, to encourage re-attachment but concurrently prevent cessation of blood flow.

The body may be provided in configurations having varying diameters of the diameter of both the axial chamber and the circumference to accommodate different sized patient tissues. In this mode, the cylindrical body may be provided in a kit having the varying dimensions allowing the surgeon to choose an appropriate size.

In an alternative mode, allowing sizing by the surgeon, the cylindrical body may be provided with a plurality of frangible sections which may be removed to alter one or both of the axial cavity diameter and the circumference. The foam or soft material forming the body would be formed in somewhat of a cinnamon roll type configuration where the material forming the body is sliced in coaxial rings allowing removal of circular portions to change the diameter of the axial cavity and the exterior circumference. This mode of the device lessens the number of different sized cylindrical bodies that may have to be provided the surgeon, lessening the amount of surgical room inventory. If desired, one or a plurality of horizontal cuts may be formed to allow a variation of the height of the formed body.

It is of importance of the device to be of such material as to be absorbent. It is common practice to place an antibiotic soaked gauze about the nipple, as in methods described in prior art. Soaking the device in antibiotics will replace the need for this extra step. The device may be soaked in a reacting agent as to detect the presence of infection occurring on the operation site, warning the patient that a visit to the doctor is recommended. It is preferable for the device to be white in color to visually detect the presence of blood as well. As mentioned previously, it is important to apply the correct amount of pressure to the operation site so as to allow for swift and effective healing. Currently this is done simply at the surgeon's discretion. A systematic means to achieve this however, can be done by printing a series of horizontal dashed indicator lines at predetermined spacings in a column along the vertical length on the side wall of the device. As pressure is applied and the device collapses onto itself, the lines will conform similarly. As lines from the upper and lower section of the device touch, an estimate of pressure can be determined based off the material properties and spacing of the indicators.

The preferred use of the device is to place the invention over the nipple and areola once the inner diameter and overall height has been determined by a physician. The physician will then apply pressure to the device as indicated by the markings on it's side wall and secure the device with a clear medical adhesive tape such as TEGADERM clear film.

With respect to the above description, it is to be understood that the invention is not limited in its application to the details of operation of the nipple/areola protective cover nor the arrangement of the components or steps in the method set forth above or in the following descriptions or in the illustrations in the drawings. The various methods of implementation and operation of the disclosed device herein, are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

Therefor, those skilled in the art will appreciate that the conception upon which this disclosure is based may readily be utilized as a basis for designing similar nipple/areola protective covers for carrying out the several purposes of the present invention. Therefore, the objects and claims herein should be regarded as including such equivalent constructions, steps, and methodology insofar as they do not depart from the spirit and scope of the present invention.

It is an object of the invention to provide a safe and reliable means to protect a nipple and areola post operation.

It is another object of the invention to allow for variance in the inner cavity diameter as well as vertical height by means of removable engagement of components of the device. This will allow the device to conform to specific requirements determined by a physician.

It is yet another object of the invention to provide a means to determine the pressure imposed by the device onto a patient.

Still another object of the invention is to allow for a means of early detection of bleeding or infection occurring at the operation site such as soaking the device in reacting agents.

### BRIEF DESCRIPTION OF THE FIGURES

FIG. 1 is a top view of the device showing the axial cavity, and removably engaged inner cylindrical sections.

FIG. 2 is an isometric view of the device depicting the orientation of the axial cavity and removably engaged inner cylindrical sections.

FIG. 3 is a side view of the device as described in FIG. 2.

FIG. 4 is a side view of the device depicting the removably engaged sections about the vertical height of the device described in FIG. 2.

FIG. 5 is an isometric view of the device showing the orientation of the removably engaged sections as described in FIG. 3.

FIG. 6 shows a preferred mode of the device depicting a measuring system to provide the user with a means to determine applied pressure.

FIG. 7 is a side view of the measuring system as described in FIG. 6.

FIG. 8 shows the as-used deployment of the pressure measuring system as described in FIG. 6.

FIG. 9 is an exploded view of the device detailing the removably engaged sections as described in FIGS. 2 and 5.

FIG. 10 depicts a sliced view of a body of the device similar to that of FIG. 4, but in a mode of the device wherein the axial cavity is formed as a recess in the bottom surface and does not communicate with the with the top surface.

### DETAILED DESCRIPTION OF THE PREFERRED EMBODIMENTS OF THE INVENTION

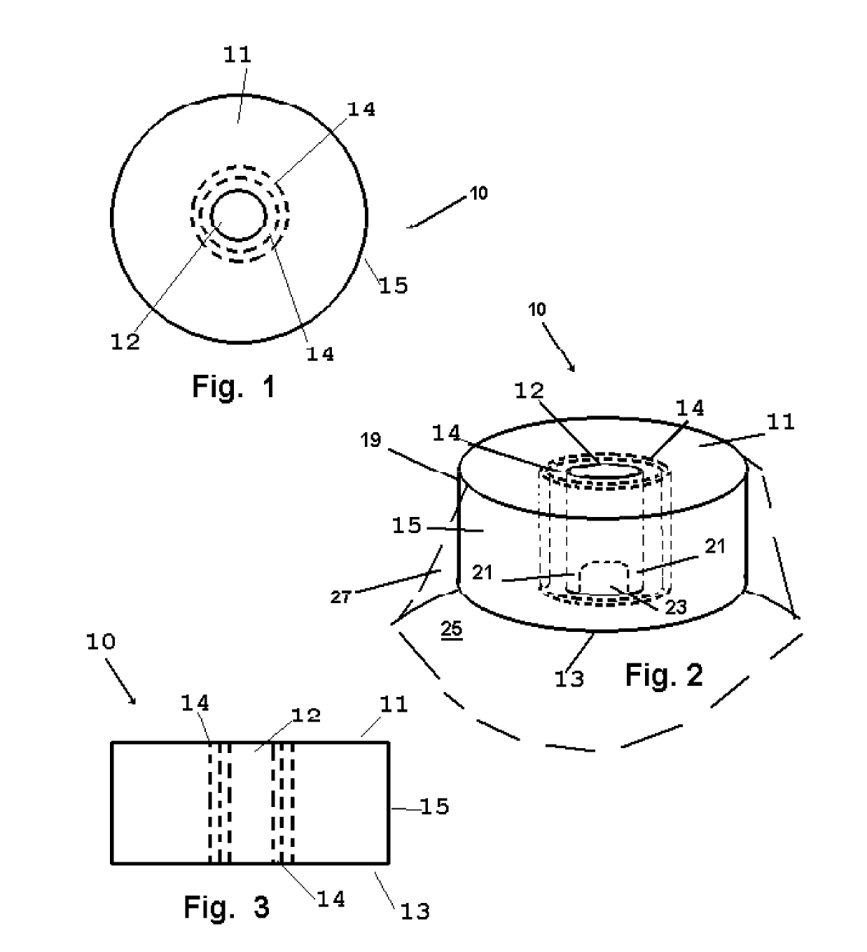

Now referring to drawings in FIGS. 1-8, wherein similar components are identified by like reference numerals, there is seen in FIG. 1 the device 10 depicting the axial cavity 12, defined by an annular sidewall surrounding the center axis of the axial cavity 12. Also shown are a first or top surface 11 and a sidewall 15 which defines the outer circumference and overall diameter of the device 10.

In the mode of the device 10 shown in FIGS. 1-3, a means to adjust the diameter of the axial cavity 12 is provided by one or a plurality of frangible portions of a central portion of the resilient member or body 19 which are removably engaged concentric cylindrical members 14. The material forming the body 19 being resilient, such as foam, it may be perforated or slit partially between the top and bottom surfaces to allow for the easy removal of the central portion formed by cylindrical members 14 removably attached to the body 19 in series, to enlarge the diameter of the axial cavity 12 in ever larger steps. By employing this means of adjustment of the diameter of the axial cavity 12 running between, and communicating with, the top surface 11 and bottom surface 13, the surgeon may adjust the size of the annular gap 21 surrounding the nipple 23 of a patient if needed. This mode of the device 10 would allow for a single packaged body 19 with frangible portions, to accommodate many different patients, having different physical characteristics of breast 25 size when positioned thereon as in FIG. 2 where the device 10 is shown in the as-worn position held by a bandaging 27 which is preferably substantially transparent to provide a view of the resilient material forming the body 19 when in this position.

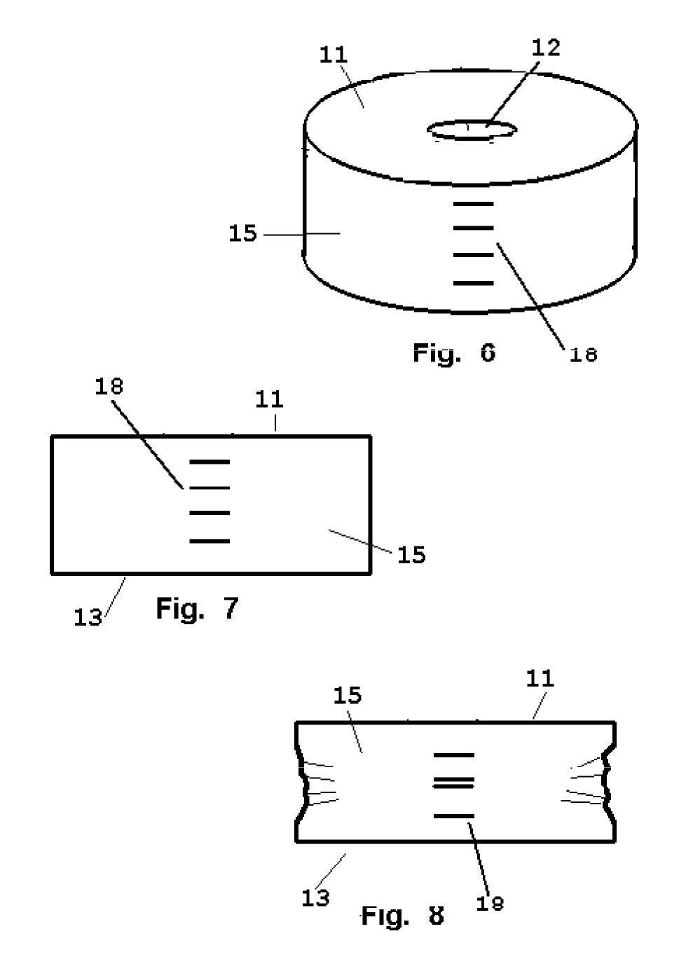

In a mode of the device 10, depicted in FIG. 6, there is shown a single axial cavity 12 having a diameter adapted to surround a nipple 23 with a gap as in FIG. 2 which has a body 19 of unitary construction. In this mode, the body 19 is formed of resilient material having an axial cavity 12 and can be provided in various sizes with smaller and larger diameter axial cavities 12 to allow the surgeon to choose one of the plurality in the kit, which fits best and provides the gap 21. In this mode the resilient members forming the body 19 would be packaged in sterile packages like the device of FIG. 2, and provided in sizes that allow the surgeon to choose.

Of course in the mode of the device of FIGS. 1-3, the device 10 is not limited in the number of such removably engaged cylindrical members 14 and only two are shown for reasons of simplicity. However, any one or a plurality of removable cylindrical members may be employed which will yield the requisite adjustability to the body 19 required. Both modes of the device 10 thus may be provided in a manner that allows the surgeon to choose a body 19 with appropriate dimensions for the patient. Thus, upon the discretion of a physician, either a pre-sized unitary body 19 from a plurality of bodies 19 in a kit or selection may be chosen, or one or a plurality of the removably engaged cylindrical members 14 may be removed from a device 10 having the body 19 with frangible portions. In either manner the device 10 may be adjusted to accommodate the physical attributes of the patient though adjusting the diameter of the axial cavity 12 as determined necessary.

The customization allowable by the removably engaged sections 14, or the provision of a kit of a plurality of defiantly dimensioned bodies 19, greatly increase the comfort level and the chance for swifter recovery for the patient. The isometric view and side view of the device 10 seen in FIGS. 2 and 3 respectively depict the removably engaged sections prior to removal compared to the vertical height of the device 10 as well as the bottom surface 13 and side wall 15.

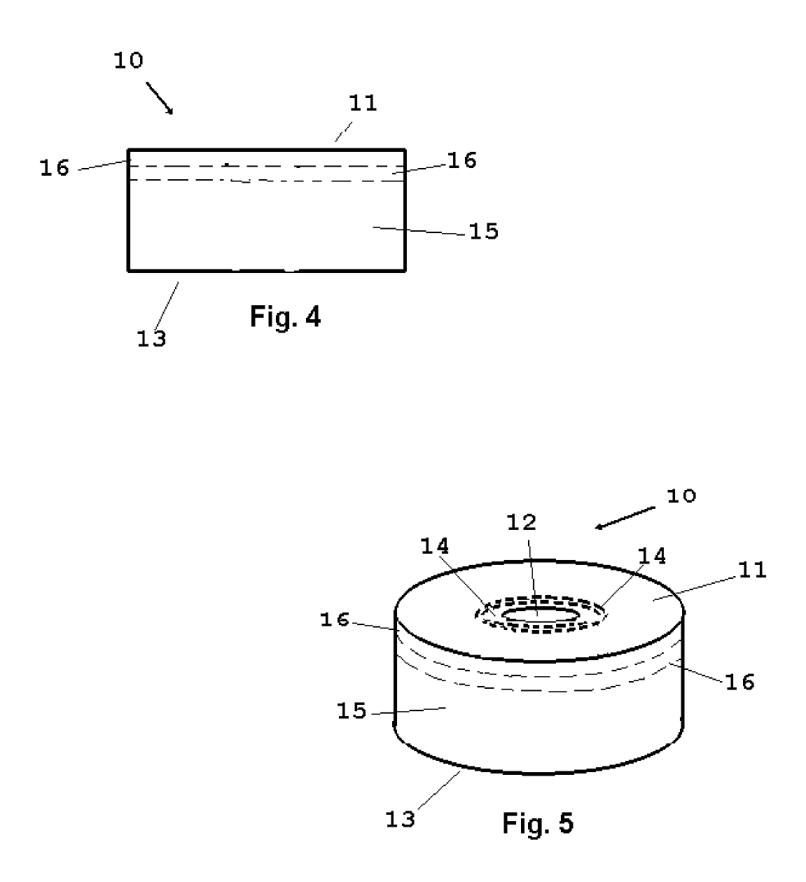

FIG. 4 depicts a side view of a resilient member forming a body 19 employing one, or as shown, a plurality of optional removably engaged horizontal members 16. If employed, the removal of these horizontal members allow for discrete height changes to be made to the body 19 of the device 10. This mode of the device allows a physician to uniquely modify the device 10 by means of removable discrete height adjusting horizontal members 16 and provides a means to adjust the downward pressure of the body 19 upon the breast 25 tissue in the as-used position in case less pressure is desirable or bandaging 27 concerns require a lower profile.

As used herein, top surface and bottom surface are for ease of description only and are not meant to limit the device 10 or its orientation in any fashion. Those skilled in the art will realize that the body 19 may be oriented in either direction and still achieve an improved bandage engageable on the breast 25 and providing the protective padded cocoon of the gap 21 surrounding the projecting tissue of the nipple which projects above the skin of the patient and into the axial cavity 12. Further, the number and thickness of the removable members 16 can be varied and are not limited to the depictions set forth in FIGS. 4 and 5.

As noted earlier, it is preferred to allow the device 10 to provide a biasing pressure to the skin of the breast 25 when it is in the as-used position of FIG. 2 held by bandaging 27. This pressure aids in the re-attachment of the skin to the underlying tissues. The use of substantially transparent bandaging 27 and resilient material forming the body 19 having a light color or preferably white color combined to yield a means to ascertain excess bleeding or infection when the device is in the as-worn position, without dismounting it. The resilient material being a foam or the like, will absorb blood and fluids which might leak from the incisions or areas of the breast 25 on which it sits. Excess bleeding will be readily apparent as the resilient material will absorb it and by capillary action the blood rises along the sidewall 15 toward the top 11.

Currently a preferred material to form the resilient member or body 19 of the device 10 is HYDROSORB which has a durometer of substantially 5.5 lb/ft or another amorphous hydrogel type foam or a foam product with similar properties. This material in a white color, to provide the means to visually discern excess bleeding, works quite well. However those skilled in the art will no doubt realize that other amorphous hydrogel type foam products may be employed, or other foam material with similar durometer properties between 4.5 and 6.5 lb/ft preferably, and with similar absorption properties. Any such foam or padding material which one skilled in the art might substitute for the noted material herein, is considered within the scope of this patent.

When in the as-used position of FIG. 2, blood on the sidewall 15 which rises due to capillary action, will be apparent to both the patient and the doctor and early detection is possible. Infection can also be discerned in the same fashion as the fluids and blood absorbed by the resilient material of the body 19 will be visible and generally discolor from a red to other colors. Consequently, the use of substantially transparent bandaging 27 and light colored or white resilient material forming the body 19 provide a means to view and ascertain excess bleeding and infection when the device is in the as-used position of FIG. 2.

In another optional mode, the device may be configured with means to determine the biasing or pressure applied by the device 10 to the skin and tissue of the underlying breast 25. As shown in FIGS. 6, 7 and 8, a scale is provided by a sequence of inline markings 18 on the side wall 15 of the device 10 running from the top surface 11 to the bottom surface 13. As pressure is applied to the top surface 11 of the resilient material of the body 19 of device 10, the body compresses onto itself as depicted in FIG. 8 and experimentation has shown that the sidewall 15 compacts toward its center a distance in a middle portion up the vertical height of the sidewall 15. This displacement can form a scale for pressure provided by the resilient material trying to re-expand, and can be measured by observing a two or more of markings 18 remaining in an adjacent position such as depicted in FIG. 8. The displacement depicted by the markings 18 is proportional to the outward biasing of the resilient material against the skin and tissue of the underlying breast 24 when in the as-used position. The placement of the of the markings 18, and the force related to the scale may be easily determined by testing of the bodies 19 and calculated by the hardness or expansion properties of the resilient material forming the body 19.

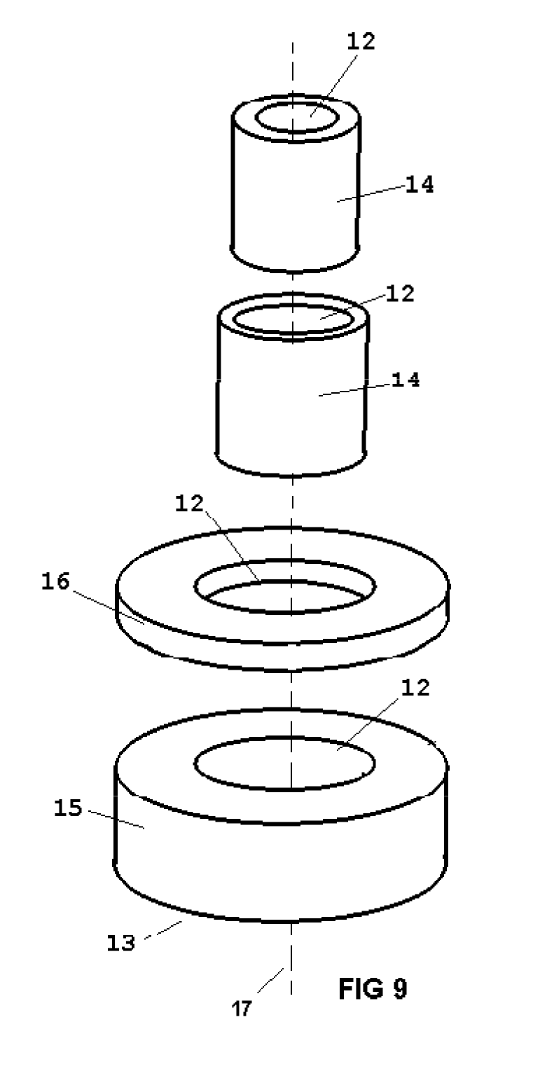

FIG. 9 is a depiction of an exploded view of the device 10 with all of the optional removably engaged portions about a center axis 17 of the axial cavity 12. As noted, in use, as one or a plurality of the concentrically engaged cylindrical members 14 are removed from the device 10 the diameter of the axial cavity 12 gradually becomes larger. Also depicted is the optional removably engaged horizontal member 16 that allows for vertical height adjustment and concurrent adjustment. Again if employed, the number and thickness of such removably engaged horizontal members 16 is not limited to that depicted in the figure.

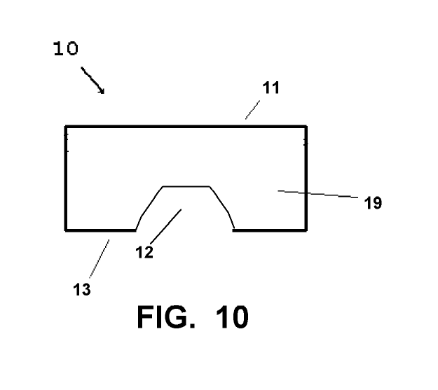

FIG. 10 depicts a sliced view of a body 19 of the device 10 similar to that of FIG. 4, but in a mode of the device 10 wherein the axial cavity 12 in a central portion of said body 19 is dimensioned as a recess in the bottom surface 13 extending toward, but not communicating with the top surface 11. This mode of the device will still provide the gap 21 to surround the nipple of the patient and protect it from abrasion and pressure, but also provides a top wall formed of the top surface 11 to protect the nipple within the axial cavity 12.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention.

Consequently, all such modifications and variations and substitutions are included within the scope of the invention as defined by the following claims.

What is claimed is:

1. A protective bandage for covering the skin of a patient comprising:
a body formed of resilient material, said body having a shape defined by a first surface, a second surface, and a sidewall communicating between said first surface and said second surface;
a cavity, said cavity recessing into a central portion of said body from an aperture communicating with said second surface, said cavity extending toward said first surface from said aperture;
said cavity having a perimeter defined by said aperture and a cavity sidewall communicating therewith; and
said perimeter sized to surround and form a gap between projecting tissue extending above said skin of said patient and said cavity sidewall; and
whereby said gap provides means to prevent a contact of said body with said projecting tissue, when said body is in an engaged position with said second surface in a contact with said skin.

2. The protective bandage of claim 1, additionally comprising:
said cavity communicating between said second surface and said first surface.

3. The protective bandage of claim 1, additionally comprising:
said skin covering the breast of said patient;
said projecting tissue being tissue defining a nipple upon said breast of said patient;
adhesive means to maintain said second surface in contact with said skin in said engaged position; and whereby said protective bandage protects said nipple from said contact when in said engaged position.

4. The protective bandage of claim 2, additionally comprising:
said skin covering the breast of said patient;
said projecting tissue being tissue defining a nipple upon said breast of said patient;
adhesive means to maintain said second surface in contact with said skin in said engaged position; and whereby said protective bandage protects said nipple from said contact when in said engaged position.

5. The protective bandage of claim 3, additionally comprising:
said adhesive means to maintain said second surface in contact with said skin being a substantially transparent bandage;
said resilient material forming said body having a color contrasting a color of blood;
said resilient material forming said body being blood absorbent material; and whereby an absorbing of said blood by said resilient material is visible through said substantially transparent bandage providing visual means to ascertain bleeding of said patient.

6. The protective bandage of claim 4, additionally comprising:
said adhesive means to maintain said second surface in contact with said skin being a substantially transparent bandage;
said resilient material forming said body having a color contrasting a color of blood;
said resilient material forming said body being blood absorbent material; and whereby an absorbing of said blood by said resilient material is visible through said substantially transparent bandage providing visual means to ascertain bleeding of said patient.

7. The protective bandage of claim 3, additionally comprising:
said adhesive means engageable in a contact upon said first surface;
said contact of said adhesive means imparting a compression of said resilient material forming said body;
said compression imparting a compressive force to said skin covering said breast of said patient; and
said compressive force providing means to hold said skin against underlying tissue to aid in a re-attachment of said underlying tissue to said skin.

8. The protective bandage of claim 4, additionally comprising:
said adhesive means engageable in a contact upon said first surface;
said contact of said adhesive means imparting a compression of said resilient material forming said body;
said compression imparting a compressive force to said skin covering said breast of said patient; and
said compressive force providing means to hold said skin against underlying tissue to aid in a re-attachment of said underlying tissue to said skin.

9. The protective bandage of claim 5, additionally comprising:
said adhesive means engageable in a contact upon said first surface;
said contact of said adhesive means imparting a compression of said resilient material forming said body;
said compression imparting a compressive force to said skin covering said breast of said patient; and
said compressive force providing means to hold said skin against underlying tissue to aid in a re-attachment of said underlying tissue to said skin.

10. The protective bandage of claim 6, additionally comprising:
said adhesive means engageable in a contact upon said first surface;
said contact of said adhesive means imparting a compression of said resilient material forming said body;
said compression imparting a compressive force to said skin covering said breast of said patient; and
said compressive force providing means to hold said skin against underlying tissue to aid in a re-attachment of said underlying tissue to said skin.

11. The protective bandage of claim 3, additionally comprising:
said first and said second surfaces each having substantially circular perimeters;
said sidewall extending between said perimeters;
said shape of said body being substantially cylindrical;
a portion of said skin being the areola area of said breast; and
said perimeter defining a surface area of said second surface, said surface area covering substantially all of said areola when said body is in said engaged position.

13. The protective bandage of claim 4, additionally comprising:
said first and said second surfaces each having substantially circular perimeters;
said sidewall extending between said perimeters;
said shape of said body being substantially cylindrical;
a portion of said skin being the areola area of said breast; and
said perimeter defining a surface area of said second surface, said surface area covering substantially all of said areola when said body is in said engaged position.

14. The protective bandage of claim 5, additionally comprising:
said first and said second surfaces each having substantially circular perimeters;
said sidewall extending between said perimeters;
said shape of said body being substantially cylindrical;
a portion of said skin being the areola area of said breast; and
said perimeter defining a surface area of said second surface, said surface area covering substantially all of said areola when said body is in said engaged position.

15. The protective bandage of claim 6, additionally comprising:
said first and said second surfaces each having substantially circular perimeters;
said sidewall extending between said perimeters;
said shape of said body being substantially cylindrical;
a portion of said skin being the areola area of said breast; and
said perimeter defining a surface area of said second surface, said surface area covering substantially all of said areola when said body is in said engaged position.

16. The protective bandage of claim 7, additionally comprising:
said first and said second surfaces each having substantially circular perimeters;
said sidewall extending between said perimeters;
said shape of said body being substantially cylindrical;
a portion of said skin being the areola area of said breast; and
said perimeter defining a surface area of said second surface, said surface area covering substantially all of said areola when said body is in said engaged position.

17. The protective bandage of claim 8, additionally comprising:
said first and said second surfaces each having substantially circular perimeters;
said sidewall extending between said perimeters;
said shape of said body being substantially cylindrical;
a portion of said skin being the areola area of said breast; and
said perimeter defining a surface area of said second surface, said surface area covering substantially all of said areola when said body is in said engaged position.

18. The protective bandage of claim 9, additionally comprising:
said first and said second surfaces each having substantially circular perimeters;
said sidewall extending between said perimeters;
said shape of said body being substantially cylindrical;
a portion of said skin being the areola area of said breast; and
said perimeter defining a surface area of said second surface, said surface area covering substantially all of said areola when said body is in said engaged position.

19. The protective bandage of claim 10, additionally comprising:
said first and said second surfaces each having substantially circular perimeters;
said sidewall extending between said perimeters;
said shape of said body being substantially cylindrical;
a portion of said skin being the areola area of said breast; and
said perimeter defining a surface area of said second surface, said surface area covering substantially all of said areola when said body is in said engaged position.

20. The protective bandage of claim 1, additionally comprising:
said central portion of said body being removable about a perimeter edge; and
a removal of said central portion providing means to enlarge said gap.

21. The protective bandage of claim 2, additionally comprising:
said central portion of said body being removable about a perimeter edge; and
a removal of said central portion providing means to enlarge said gap.
